(19) United States
(12) Patent Application Publication
(10) Pub. No.: US 2020/0400854 A1
(43) Pub. Date: Dec. 24, 2020

(54) RECEIVING COMPENSATION APPARATUS FOR AIRBORNE TRANSIENT ELECTROMAGNETIC METHOD

(71) Applicant: INSTITUTE OF GEOLOGY AND GEOPHYSICS, THE CHINESE ACADEMY OF SCIENCES, Beijing (CN)

(72) Inventors: Qingyun DI, Beijing (CN); Qihui ZHEN, Beijing (CN)

(21) Appl. No.: 16/884,001

(22) Filed: May 26, 2020

Related U.S. Application Data
(63) Continuation of application No. PCT/CN2019/092461, filed on Jun. 24, 2019.

(30) Foreign Application Priority Data
Jun. 21, 2019 (CN) 201910540518.7

(51) Int. Cl. G01V 3/10

(52) U.S. Cl. CPC G01V 3/107

(57) ABSTRACT

This application relates to a receiving compensation apparatus for an airborne transient electromagnetic method. The receiving compensation apparatus for the airborne transient electromagnetic method in this application includes a received coil, a transmitting coil, compensation coils, and at least one compensation magnetic core, where the transmitting coil is disposed on the periphery of the received coil, the compensation magnetic core is disposed on the transmitting coil, and the compensation coils are disposed on the compensation magnetic core.

### CROSS-REFERENCE TO RELATED APPLICATIONS

This application is a continuation application of International Application No. PCT/CN2019/092461, filed on Jun. 24, 2019, which claims priority to Chinese Patent Application No. 201910540518.7, filed on Jun. 21, 2019, The disclosures of the aforementioned patent applications are hereby incorporated by reference in their entireties.

### TECHNICAL FIELD

This application relates to the field of metallic ore exploration technologies, and in particular, to a receiving compensation apparatus for an airborne transient electromagnetic method.

### BACKGROUND

An airborne transient electromagnetic method is a widely used method worldwide for exploring metallic ores in recent years, has advantages such as a high speed, high efficiency, a large exploration depth, high resolution, and small impact from topography, and so, is especially suitable for shallow overburden regions where operations encounter great difficulty.

A positional relationship between a transmitting coil and a received coil for the existing airborne transient electromagnetic method is shown in FIG. 1. The transmitting coil and the received coil a located on the same horizontal plane, which are usually similar to two concentric circles in terms of shape. The transmitting coil has a radius of about 25 meters and three to six turns. The received coil has a radius of about 1 meter and more than 100 turns. The transmitting coil has relatively large inductance and a transmission current up to hundreds of amperes. When transmission is disabled, the transmission current cannot immediately fall to zero, but with a relatively long current falling time. In this process, a very large induction voltage with no geological information is produced on the received coil, and, a signal of a secondary field that carries geological information is blocked and cannot be identified. To eliminate the strong interference caused by this primary field, existing solution at home and abroad, is using a compensation coil which is usually placed at ⅓ of the radius of the transmitting coil, and also, their current direction is opposite, both coils are in the same loop, so that the induction signal is eliminated, which is generated by the primary field, as shown in FIG. 2. The transmission compensation coil usually has one turn. Magnetic fields produced by the transmitting coil and the transmission compensation coil close to the received coil have opposite directions; therefore, an induction signal of the primary field in which current falling occurs can be greatly suppressed on the received coil.

Disadvantages of the existing receiving compensation method are as follows: The transmission compensation coil can greatly suppress the induction signal of the primary field, but it is difficult to achieve theoretical suppression effects in actual implementation, because the position of the compensation coil impacts the compensation effects. The transmitting coil usually uses a polygon to approximate a circle, and it is difficult to adjust the compensation coil to an ideal position. Consequently, the receiving magnetic field is undercompensated or overcompensated, and a truly ideal measurement signal cannot be obtained. In addition, the transmission compensation coil weakens energy injected into the earth by the primary field, reduces strength of the secondary field, and weakens an exploration effect ability.

### SUMMARY

This application provides a receiving compensation apparatus for an airborne transient electromagnetic method, to resolve at least one of the foregoing technical problems in the prior art to some extent.

To resolve the foregoing problem, this application provides the following technical solutions:

A receiving compensation apparatus for an airborne transient electromagnetic method includes a received coil, a transmitting coil, compensation coils, and at least one compensation magnetic core, where the transmitting coil is disposed on the periphery of the received coil, the compensation magnetic core is disposed on the transmitting coil, and the compensation coils are disposed on the compensation magnetic core.

The technical solutions used in embodiments of this application further include that the transmitting coil and the received coil are on a concentric circle.

The technical solutions used in the embodiments of this application further include that the compensation magnetic core is a magnetic ring, and the compensation magnetic core is sleeved on the transmitting coil.

The technical solutions used in the embodiments of this application further include that the compensation magnetic core abuts on the transmitting coil.

The technical solutions used in the embodiments of this application further include that a neutralization method for the compensation coil and the received coil is that the compensation coil and the received coil respectively process two signals and neutralize the two signals by using an addition/subtraction circuit.

The technical solutions used in the embodiments of this application further include that a neutralization method for the compensation coil and the received coil is that the received coil and the compensation coil are connected into a loop to implement direct neutralization of signals of a primary field.

The technical solutions used in the embodiments of this application further include that the receiving compensation apparatus for the airborne transient electromagnetic method further includes a shielded twisted pair, the shielded twisted pair is disposed between the transmitting coil and the compensation coil, and the shielded twisted pair connects the received coil to the compensation coil.

The technical solutions used in the embodiments of this application further include that the compensation coils disposed on the compensation magnetic core are evenly wound.

The technical solutions used in the embodiments of this application further include that the multi-compensation magnetic core is connected to each other by using a wire.

Compared with the prior art, the embodiments of this application have the following beneficial effects: According to the receiving compensation apparatus for the airborne transient electromagnetic method in the embodiments of this application, compensation is made for the received coil, so that it is more flexible to debug the receiving compensation apparatus and more convenient to assemble the receiving compensation apparatus, and also, more complete suppression is implemented. In addition, the provided receiving compensation coils weaken neither energy injected into the earth by the primary field nor a signal of a secondary field, and exert no impact on the exploration ability. In this way, complete compensation of the primary field can be implemented, and therefore a cleaner signal of the secondary field can be obtained, thereby greatly improving an exploration depth and resolution.

### BRIEF DESCRIPTION OF DRAWINGS

FIG. 1 is a diagram of a positional relationship between a transmitting coil and a received coil for an existing airborne transient electromagnetic method;

FIG. 2 is a schematic structural diagram of a transmission compensation coil for an existing airborne transient electromagnetic method;

FIG. 3 is a schematic structural diagram of a receiving compensation apparatus for an airborne transient electromagnetic method according to embodiments of this application;

FIG. 4 is a schematic diagram of a connection relationship between a received coil and a compensation coil;

FIG. 5 shows distribution of magnetic induction strength around a transmitting coil; and

FIG. 6 and FIG. 7 are respectively schematic diagrams of distribution of magnetic induction strength in a radial direction B_{y} and an axial direction B_{z}.

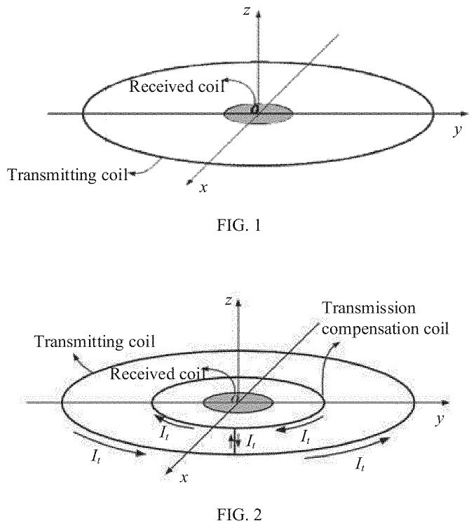

### DESCRIPTION OF EMBODIMENTS

To make the objectives, technical solutions, and advantages of this application more clearly, the following further describes this application in detail with reference to the accompanying drawings and embodiments. It should be understood that the specific embodiments described herein are merely intended to explain this application, and are not intended to limit this application.

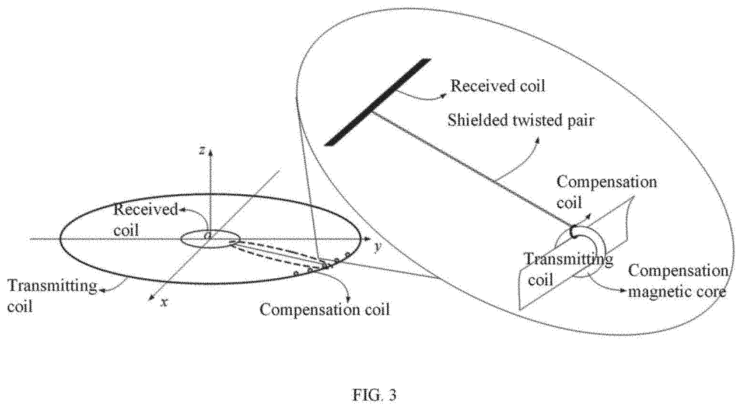

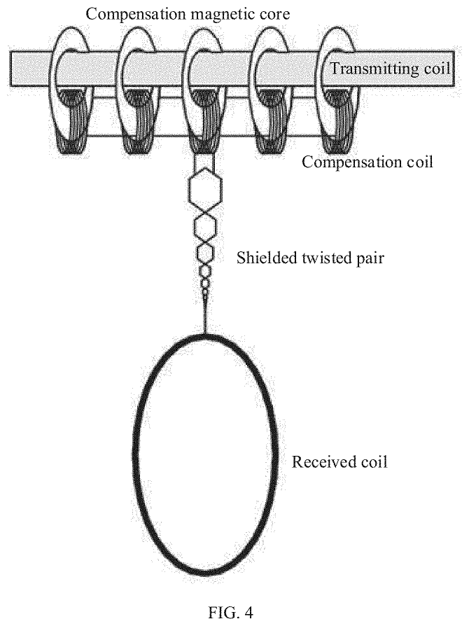

FIG. 3 is a schematic structural diagram of a receiving compensation apparatus for an airborne transient electromagnetic method according to embodiments of this application. The receiving compensation apparatus for the airborne transient electromagnetic method according to the embodiments of this application includes a transmitting coil, a received coil, at least one compensation magnetic core, and multiple compensation coils. The compensation magnetic core is a magnetic ring, which is disposed on the periphery of the received coil, and the compensation magnetic core is sleeved on the transmitting coil. Multiple compensation coils are disposed on compensation magnetic core, and the multiple compensation coils are separated by a specific gap. All the compensation magnetic cores are connected to each other by using a wire, and the received coil is connected to a compensation coil by using a shielded twisted pair. Specifically, FIG. 4 is a schematic diagram of a connection relationship between the received coil and the compensation coil.

In the embodiments of the present invention, the transmitting coil and the received coil are on a concentric circle, or the transmitting coil and the received coil may not be on a concentric circle. It is assumed that a radius of the transmitting coil is R, a flowing current is I, and a cartesian coordinate system is placed as shown in FIG. 3. Because of symmetry of the transmitting coil, only magnetic field distribution in the plane yoz needs to be calculated, and components y and z are radial and axial components respectively. Any point P(0, y₀, z₀) in the plane yoz is selected. In this case, components of magnetic induction strength of the transmitting coil at the point P are as follows:

$$\begin{matrix}where \{ \begin{matrix}{B}_{x} = \int {dB}_{x} = \frac{nR {μ}_{0} {I}_{0}}{4 π} {\int }_{0}^{2 π} \frac{cos θ \cdot {z}_{0}}{{r}^{3}} d θ \\ {B}_{y} = \int {dB}_{y} = \frac{nR {μ}_{0} {I}_{0}}{4 π} {\int }_{0}^{2 π} \frac{sin θ \cdot {z}_{0}}{{r}^{3}} d θ \\ {B}_{z} = \int {dB}_{z} = \frac{nR {μ}_{0} {I}_{0}}{4 π} {\int }_{0}^{2 π} \frac{( R - {y}_{0} sin θ )}{{r}^{3}} d θ\end{matrix} \\ & ( 1 ) \\ r = \sqrt{{( R cos θ )}^{2} + {( {y}_{0} - R sin θ )}^{2} + {z}_{0}^{2}} & ( 2 )\end{matrix}$$

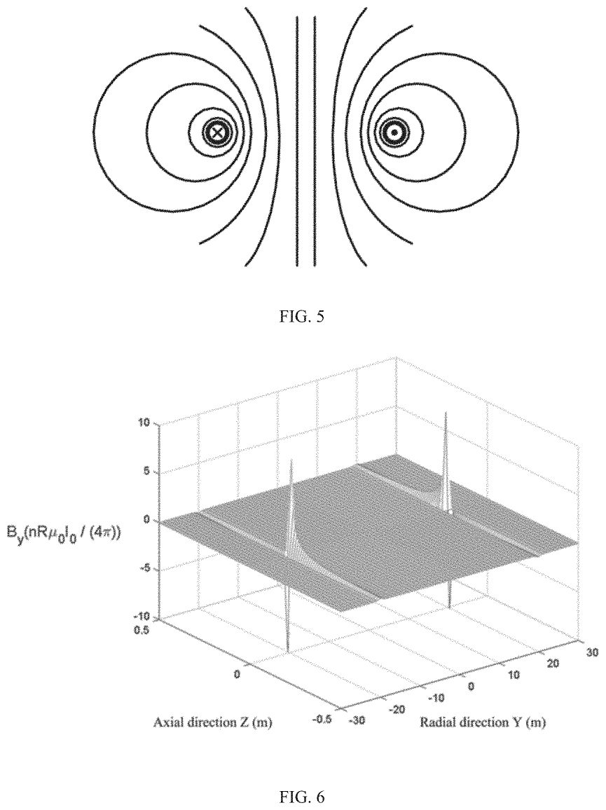

According to the formula (1), it is clear that Bₓ=0, B_{y}≠0, and B≠0, in other words, the magnetic induction strength of the transmitting coil has only the radial and axial components, and magnetic field distribution features of the transmitting coil can be described by using a two-dimensional diagram. Specifically, FIG. 5 shows distribution of the magnetic induction strength around the transmitting coil.

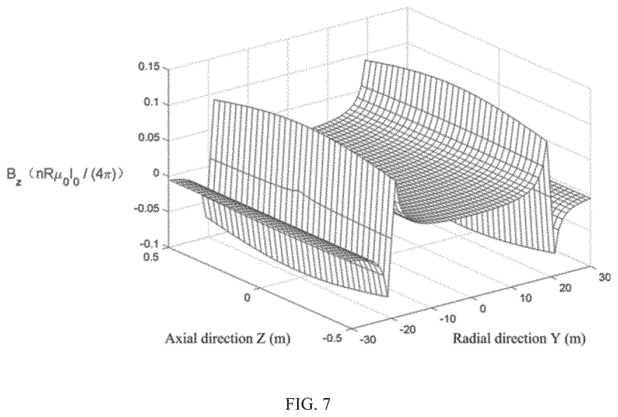

It is assumed that the radius of the coil is R=20 m, and spatial distribution of the magnetic induction strength around the coil in the radial direction B_{y} and the axial direction B_{z} can be obtained by using a Matlab numerical integration method, as shown in FIG. 6 and FIG. 7. A position of the compensation coil is near a position at which z=0 and R=±20 m. At this position, the component B_{y} is the largest, while the component B_{z} is almost equal to 0.

A vertical component of an airborne electromagnetic secondary field is usually far greater than a horizontal component, and the compensation coil should be placed on the edge of the transmitting coil. A cross-sectional area and a length of the compensation coil should be small enough, so that the compensation coil cannot capture a signal of the secondary field, and a resonant frequency of the compensation coil should be far higher than a frequency of a transmission switch. The compensation coil is designed, so that the transmitting coil produces the same flux linkage as the received coil. The flux linkage that passes through the received coil is first calculated, and then parameters of the compensation coil are designed based on the flux linkage.

If the compensation coil is also a hollow coil, the requirement for a small enough cross-sectional area and length cannot be met. Therefore, according to the receiving compensation apparatus for the airborne transient electromagnetic method in the embodiments of this application, the at least one compensation magnetic core is disposed, and the compensation coil surrounds the compensation magnetic core. By using this structure, the compensation coil can be designed to be very small, impact of the secondary field does not need to be considered, and only a signal of a primary field is picked up.

In the embodiments of this application, methods for disposing the compensation magnetic core include the following: The compensation magnetic core may abut on the periphery of the transmitting coil, or may be separated from the transmitting coil by a specific gap. Magnetic permeability of the compensation magnetic core should not be too high, to avoid magnetic saturation. When the compensation coil fully matches the received coil, a signal of the received coil and a signal of the compensation coil are neutralized to complete compensation of the primary field. In the embodiments of this application, there are two signal neutralization methods for the compensation coil and the received coil. One method is to respectively process two signals and finally neutralize the two signals by using an addition/subtraction circuit. The other method is to directly connect the received coil and the compensation coil into a loop (as shown in the dashed-line part in FIG. 3) to implement direct neutralization of signals of the primary field. In this method, a shielded twisted pair needs to be disposed between the received coil and the compensation coil, and the transmitting coil is connected to the compensation coil by using the shielded twisted pair.

By using the foregoing structure, an induction signal after compensation is as follows:

vₜ=vᵣ−v_{c}=v₁+v₂−v₁=v₂ (3)

Where vₜ represents a combined signal, vᵣ represents a signal of the received coil, v_{c} represents a signal of the compensation coil, v₁ represents a signal of the primary field, and v₂ represents a signal of the secondary field.

The compensation of the primary field is finally implemented by using the foregoing compensation technology. If the compensation coils are evenly wound around the compensation magnetic core, the compensation coils induce no signal of the secondary field, thereby implementing complete suppression of the primary field. Uneven winding of the compensation coils exerts little but non-serious impact on compensation effects.

FIG. 6 and FIG. 7 are respectively schematic diagrams of distribution of magnetic induction strength in a radial direction B_{y} and an axial direction B_{z}. Values of B_{z} at the central position are basically uniform, and a value of a component B_{z} of the transmitting coil at the central position can be obtained by using the formula (1). If a transmission current is 100 A, the number of turns of the transmitting coil is 3, and a radius of the transmitting coil is R=25 m, magnetic induction strength of the transmitting coil at the center is 7.5 μT, If the radius of the received coil is 1 m, the flux linkage Ψ that passes through the received coil is 70.7 μWb. If a cross-sectional area S of the compensation magnetic core is 1 cm², a length of a magnetic circuit 1 is 15 cm, and the received coil has 100 turns, the number of turns of the compensation coil is as follows:

$$n = \frac{100 Ψ l}{IS {μ}_{0} {μ}_{r}} = \frac{84400}{{μ}_{r}} \qquad ( 4 )$$

When the relative magnetic permeability of the compensation magnetic core is 300, the compensation coils need to be wound by 280 turns to meet the requirement. Actually, magnetic permeability of the compensation magnetic core should not be too high; otherwise nonlinearity of the compensation magnetic core is high. A magnetic material with relative magnetic permeability less than 100, very low coercivity, and very high saturation flux density is usually selected. In addition, multiple compensation coils may be connected in series to reduce the number of turns of a single compensation coil. The compensation coils can be matched by adjusting a current of a cable that passes through the compensation magnetic core (by selecting a part of a cable of the transmitting coil to pass through the magnetic core). The compensation coils need to be evenly wound to prevent the secondary field from being coupled to the compensation coils.

According to the technical invention of this application, a positional relationship between the received coil and the transmitting coil is not limited, information about the secondary field can also be normally received even if the received coil is disposed outside the transmitting coil or inside the transmitting coil, and the positional relationship between the transmitting coil and the received coil in this application constitutes no limitation.

According to the receiving compensation apparatus for the airborne transient electromagnetic method in the embodiments of this application, compensation is made for the received coil, so that it is more flexible to debug the receiving compensation apparatus and more convenient to assemble the receiving compensation apparatus, and more complete suppression is implemented. In addition, the provided receiving compensation coils weaken neither energy injected into the earth by the primary field nor a signal of the secondary field, and exert no impact on the exploration ability. In this way, complete compensation of the primary field can be implemented, and therefore a cleaner signal of the secondary field can be obtained, thereby greatly improving an exploration depth and resolution.

Although the present invention is described with reference to the current preferred implementations, it should be understood by a person skilled in the art that the foregoing preferred implementations are merely intended to describe the present invention, and are not intended to limit the protection scope of the present invention. Any modification, equivalent replacement, improvement made within the spirit and principle of the present invention shall fall within the protection scope of the claims of the present invention.

What is claimed is:

1. A receiving compensation apparatus for an airborne transient electromagnetic method, comprising a received coil, a transmitting coil, and compensation coils, wherein the transmitting coil is disposed on the periphery of the received coil, the receiving compensation apparatus further comprises at least one compensation magnetic core, the compensation magnetic core is disposed on the transmitting coil, and the compensation coils are disposed on the compensation magnetic core.

2. The receiving compensation apparatus for the airborne transient electromagnetic method according to claim 1, wherein the transmitting coil and the received coil are on a concentric circle.

3. The receiving compensation apparatus for the airborne transient electromagnetic method according to claim 1, wherein the compensation magnetic core is a magnetic ring, and the compensation magnetic core is sleeved on the transmitting coil.

4. The receiving compensation apparatus for the airborne transient electromagnetic method according to claim 2, wherein the compensation magnetic core is a magnetic ring, and the compensation magnetic core is sleeved on the transmitting coil.

5. The receiving compensation apparatus for the airborne transient electromagnetic method according to claim 3, wherein the compensation magnetic core abuts on the periphery of the transmitting coil, or the compensation magnetic core is separated from the transmitting coil by a specific gap.

6. The receiving compensation apparatus for the airborne transient electromagnetic method according to claim 4, wherein the compensation magnetic core abuts on the periphery of the transmitting coil, or the compensation magnetic core is separated from the transmitting coil by a specific gap.

7. The receiving compensation apparatus for the airborne transient electromagnetic method according to claim 1, wherein a signal neutralization method for the compensation coil and the received coil is that the compensation coil and the received coil respectively process two signals and neutralize the two signals by using an addition/subtraction circuit.

8. The receiving compensation apparatus for the airborne transient electromagnetic method according to claim 2, wherein a signal neutralization method for the compensation coil and the received coil is that the compensation coil and the received coil respectively process two signals and neutralize the two signals by using an addition/subtraction circuit.

9. The receiving compensation apparatus for the airborne transient electromagnetic method according to claim 1, wherein a neutralization method for the compensation coil and the received coil is that the received coil and the compensation coil are connected into a loop to implement direct neutralization of signals of a primary field.

10. The receiving compensation apparatus for the airborne transient electromagnetic method according to claim 2, wherein a neutralization method for the compensation coil and the received coil is that the received coil and the compensation coil are connected into a loop to implement direct neutralization of signals of a primary field.

11. The receiving compensation apparatus for the airborne transient electromagnetic method according to claim 1, further comprising a shielded twisted pair, wherein the shielded twisted pair is disposed between the transmitting coil and the compensation coil, and the shielded twisted pair connects the received coil to the compensation coil.

12. The receiving compensation apparatus for the airborne transient electromagnetic method according to claim 2, further comprising a shielded twisted pair, wherein the shielded twisted pair is disposed between the transmitting coil and the compensation coil, and the shielded twisted pair connects the transmitting coil to the compensation coil.

13. The receiving compensation apparatus for the airborne transient electromagnetic method according to claim 1, wherein the compensation coils disposed on the compensation magnetic core are evenly wound.

14. The receiving compensation apparatus for the airborne transient electromagnetic method according to claim 2, wherein the compensation coils disposed on the compensation magnetic core are evenly wound.

15. The receiving compensation apparatus for the airborne transient electromagnetic method according to claim 1, wherein the at least one compensation magnetic core is connected by using a wire.

16. The receiving compensation apparatus for the airborne transient electromagnetic method according to claim 2, wherein the at least one compensation magnetic core is connected by using a wire.
